(19) United States
(12) Patent Application Publication
(10) Pub. No.: US 2008/0168675 A1
(43) Pub. Date: Jul. 17, 2008

(54) Portable Clothes Dryer with Multiple Drying Shelves

(75) Inventors: Michael Garman, Stafford, VA (US); Mark Turner, Mechanicsville, VA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: HAMILTON BEACH/PROCTOR-SILEX, INC., Glen Allen, VA (US)

(21) Appl. No.: 11/623,616

(22) Filed: Jan. 16, 2007

(51) Int. Cl. F26B 25/18

(52) U.S. Cl. 34/195; 34/202; 34/239; 34/390

(57) ABSTRACT

A clothes dryer comprises a plurality of generally parallel shelves. Each shelf includes at least an outer frame having a first end and a second end. Each shelf also includes a fabric extending across the frame to form a substantially planar surface. The dryer further includes a fan and a housing that encloses the fan. The housing has an extension arm and at least one air intake vent. The extension arm supports the second end of each shelf and comprises a plurality of air exhaust vents that are configured to direct air substantially parallel to the planar surface of each shelf.

### BACKGROUND OF THE INVENTION

The present invention relates to a portable clothes drying device for drying clothing and, more particularly to a light weight portable drying rack having fabric shelves.

Clothes lines are commonly strung outdoors and damp clothing is hung on the line and affixed with a pin. Wind and sunlight helps to dry the damp clothes. Similarly, standing drying racks have been utilized for hanging clothes both indoors and outdoors. Clothes lines and drying racks however, require a great deal of time to allow the clothes to dry thoroughly and may cause the hanging clothes to stretch or form over the line or rack. Outdoor lines and racks are subject to inclement weather, insects and debris. Indoor lines and racks require a great deal of space during the long period of drying time and may be subject to mold from the lack of air circulation.

To speed up the drying process, drying machines have been introduced. Conventional dryers are large and heavy machines that normally accompany a washing machine. Dryers typically include a heat source, an internal rotating drum and a door. Damp clothes are placed within the rotating drum and the door is closed. The clothing is rotated and heated as air is circulated about the clothes. The dampened air is vented through a lint filter to the outside. Dryers, however, are expensive and bulky machines that must be permanently installed and require a great deal of electricity to operate. Additionally, certain cotton, wool and other more delicate fabrics are often damaged or shrink due to the heat and tumbling involved.

It is desirable therefore, to have a lightweight portable drying rack that quickly dries clothes without shrinking or stretching the clothing.

### BRIEF SUMMARY OF THE INVENTION

Briefly stated, the present invention is directed to a clothes dryer. The dryer comprises a plurality of generally parallel shelves. Each shelf includes at least an outer frame having a first end and a second end. Each shelf also includes fabric extending across the frame to form a substantially planar surface. The dryer further includes a fan and a housing that encloses the fan. The housing has at least one air intake vent and an extension arm. The extension arm supports the second end of each shelf and comprises a plurality of air exhaust vents that are configured to direct air substantially parallel to the planar surface of each shelf.

### BRIEF DESCRIPTION OF THE SEVERAL VIEWS OF THE DRAWINGS

The foregoing summary, as well as the following detailed description of a preferred embodiment of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown.

In the drawings:

FIG. 1 is a front left perspective view of a preferred embodiment of a dryer in accordance with the present invention;

FIG. 2 is an enlarged partial front left perspective view of a shelf attached to a housing of the dryer shown in FIG. 1;

FIG. 3 is a cross sectional perspective view of the dryer taken along line 3-3 of FIG. 1;

FIG. 4 is a front elevational view of the dryer shown in FIG. 1; and

FIG. 5 is a rear left perspective view of the dryer shown in FIG. 1 partially broken away and showing a motor and impellers in the housing.

### DETAILED DESCRIPTION OF THE INVENTION

Certain terminology is used in the following description for convenience only and is not limiting. The words “right,” “left,” “lower” and “upper” designate directions in the drawings to which reference is made. The words “inwardly” and “outwardly” refer to directions toward and away from, respectively, the geometric center of a dryer in accordance with the present invention, and designated parts thereof. The terminology includes the words noted above, derivatives thereof and words of similar import.

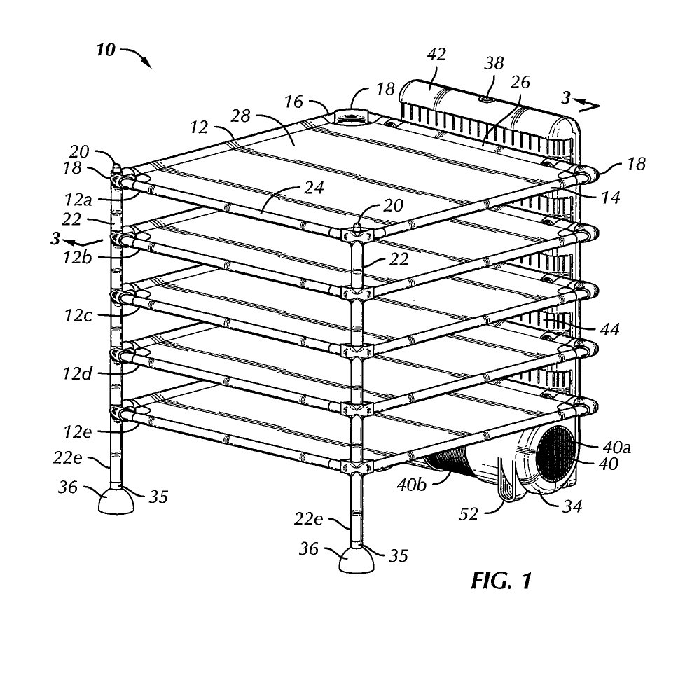

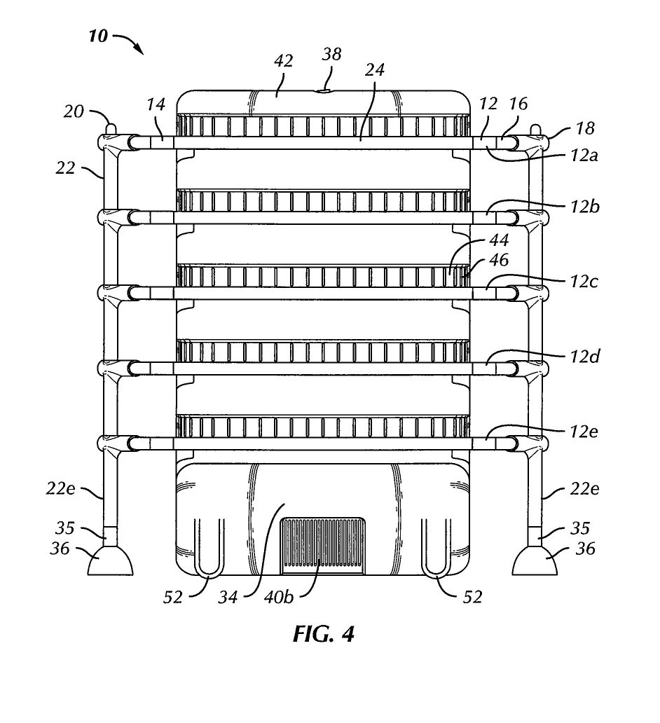

Referring to FIGS. 1-5, a clothes dryer for individually drying clothes (dryer), generally designated 10, is comprised of a plurality of generally parallel, generally equally spaced shelves 12. In the preferred embodiment, there are five shelves 12a, 12b, 12c, 12d, 12e but the dryer 10 may include any number of shelves 12 and is not limited to the preferred embodiment having five shelves 12a, 12b, 12c, 12d, 12e. The shelves 12 12b, 12c, 12d, 12e include similar features shown and labeled as the top-most shelf 12a and duplicate numbering is omitted for convenience only and is not limiting. The dryer 10 may be operated, as described further below, with one or more of the provided shelves 12a, 12b, 12c, 12d, 12e removed. Each shelf 12 includes an outer frame 14. The outer frames 14 are each comprised of four cylindrical hollow tubes 16. The tubes 16 are preferably straight and are orthogonally arranged in a plane to form the rectangular outer frame 14. Though rectangular shelves 12 are shown, the tubes 16 may be curved, include more or fewer segments and may be arranged to form any planar shape such as a square, circle or triangle. The tubes 16 are preferably comprised of a light weight thin walled aluminum or steel but may be comprised of any light-weight material such as a polymeric material. The tubes 16 are joined together by generally tubular corner fittings 18. The corner fittings 18 have an elbow shape and have a slightly larger diameter at each end than the diameter of the tubes 16 such that the tubes 16 are inserted into the corner fittings 18 preferably with at least a slight interference fit. The corner fittings 18 are preferable comprised of a polymeric material but may be comprised of aluminum or any other material known in the art. The corner fittings 18 and tubes 16 may be press fit or may include a snap or latch type connection. The corner fittings 18 located on a first end 24 of the shelves 12 each include a rounded knob 20 extending upwardly from the corner fitting 18 which is oriented generally perpendicular to the shelf 12. The corner fittings 18 on the first end 24 of each of the shelves 12 also includes a generally hollow post 22 extending downwardly and oriented generally perpendicular to the shelf 12. The upwardly extending knobs 20 are sized and shaped to fit within in a corresponding post 22 of the corner fitting 18 of an adjacent shelf 12. The first end 24 of the bottommost shelf 12e is supported from a support surface (not shown) by at least one leg 35. The legs 35 are comprised of an extended post 22e which may include foam elastomeric feet 36 at the distal end to dampen any vibrations created in the dryer 10 and to prevent the dryer 10 from sliding relative to the support surface when the support surface is smooth such as linoleum or hardwood. The extended post 22e may also be the same size as the posts 22 with an leg 35 extending to the support surface such than the shelves 12a, 12b, 12c, 12d, 12e are all interchangeable. The legs 35 may include wheels or track balls (not shown) rather than elastomeric feet 36 to allow for sliding relocation of the dryer 10.

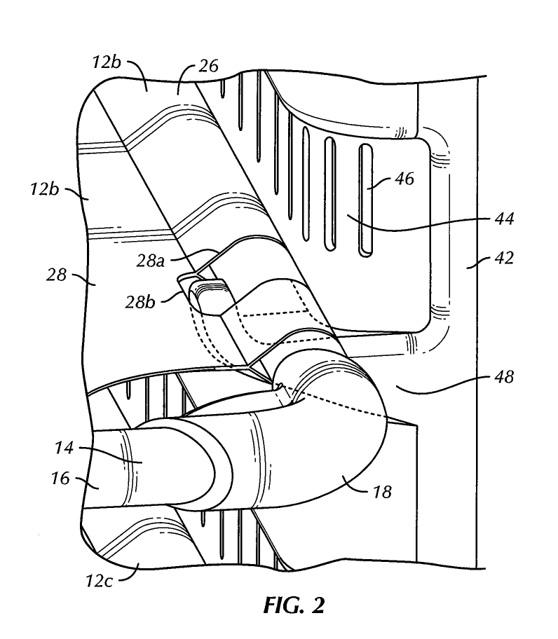

Each shelf 12 has a first end 24 and a second end 26. A fabric 28 extends across the outer frame 14 in the form of a substantially planer surface. The fabric 28 is preferably sewn around its outer periphery to form a loop 28a (FIG. 2) that allows the tube 16 of the outer frame to be inserted within the loops 28a. The loops 28a extend along the length of the tubes 16 leaving the ends of each tube 16 and the corner fittings 18 exposed to allow for assembly and disassembly. The outer frame 14 stretches the fabric 28 outwardly toward the outer periphery relatively taut such that the substantially planer surface can support a damp article of clothing (not shown) without substantial sagging. Each shelf 12 is spaced from each other in a generally parallel configuration. Each shelf 12 is spaced from an adjacent shelf 12 by the distance of each post 22. The fabric 28 is preferably a breathable nylon mesh having a plurality of holes allowing for air and moisture to more easily pass through the shelf 12 but the fabric may be comprise any light weight and flexible material such as spun polypropylene. The fabric 28 is either rolled, folded or bunched up during disassembly to allow for compact storage and easy portability of the shelves 12. The loops 28a may include an elastic sleeve (not shown) rather than the loop 28a of fabric 28 such that a tighter fit around the tubes is achieved while allowing a flex in the fabric 28 during assembly of the shelves 12. The fabric 28 stretches slightly when forming the outer frame 14 by inserting the tubes 16 into the corner fitting 18.

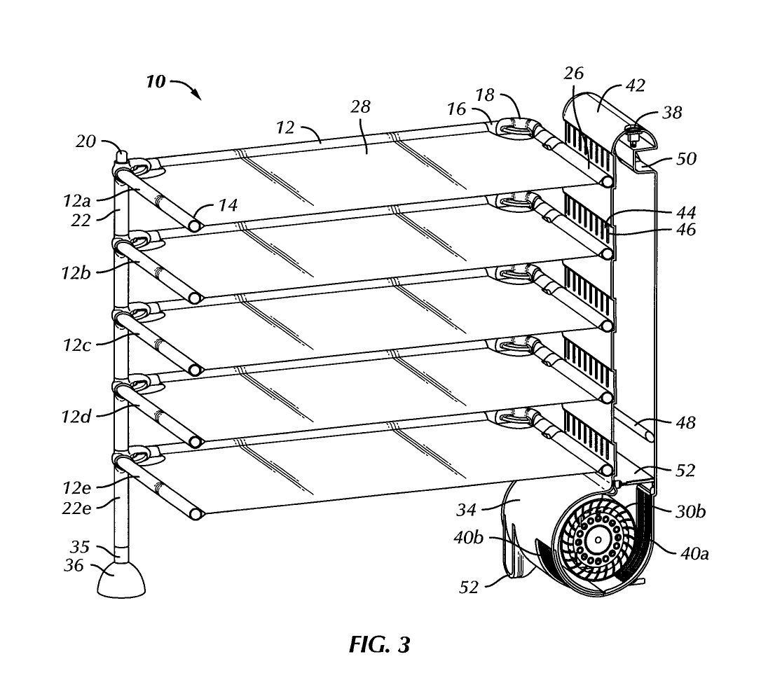

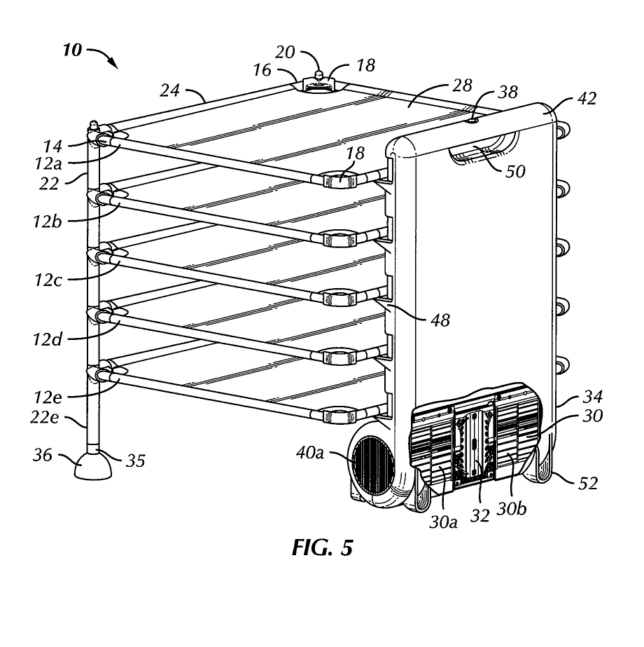

Referring to FIGS. 3 and 5, the dryer 10 includes a fan 30 which is powered by an electric motor 32. The fan 30 is comprised of a first impeller 30a and a second impeller 30b. The motor 32 is positioned between the first and second impellers 30a, 30b. The motor 32 is enclosed in a thermoplastic housing (not shown). The impellers 30a, 30b are preferably thermoplastic and the motor 32 is preferably a shaded-pole motor but the fan 30 and motor 32 may be comprised of any fan and motor assembly capable of moving blowing air and is not limited to the fan and motor assembly described and shown.

Referring to FIGS. 1-5, the dryer 10 includes a housing 34 that is assembled to enclose the fan 30 and motor 32. The housing 34 is preferably comprised of two molded polypropylene pieces joined together but may can be comprised of any material known in the art. The housing 34 includes at least one air intake vent 40 for drawing ambient air into the housing 34. The fan 30 motor 32 and intake vent 40 are preferably located below the bottommost shelf 12e. In the preferred embodiment, the intake vent 40 includes side vents 40a on either side of the impellers 30a, 30b and central vents 40b at least partially around the motor 32. The intake vents 40a, 40b are not limited to the configuration shown and may be positioned anywhere along the housing 34 surrounding the fan 30 and the motor 32. The housing 34 includes base supports or feet 52 extending from the housing 34 generally parallel to the support surface for providing stability to the housing 34. The feet 52 may be comprised of or include an elastomeric base support to dampen vibration and prevent sliding. The housing 34 also includes an extension arm 42 that extends vertically upwardly from the remainder of the housing 34 generally perpendicular to the shelves 12. The extension arm 42 is in fluid communication with the fan 30 such that the air which is drawn into the housing 34 through the intake vents 40a, 40b is forced up into the extension arm 42.

Referring to FIG. 2, the extension arm 42 includes hook like support members 48 that supports the second end 26 of each shelf 12. The support members 48 extend perpendicular from the extension arm 42 toward the first end 24 of the shelves 12 and are each curved upwardly as shown. The extension arm 42 includes at least one but preferably two support members 48 for each shelf 12. The support members 48 are vertically spaced the distance of each post 22 such that the shelves 12 are level and oriented substantially parallel to the support surface. The support members 48 are sized and shaped to fit partially around the underside of the tube 16 of each shelf 12. The fabric 28 includes a gap 28b in the loop 28a such that the support member 48 is directly in contact with the tube 16. The extension arm 42 also includes a plurality of exhaust vents 44. The exhaust vents 44 are comprised of a series of generally vertical slots 46 positioned across the surface of the extension arm 42 toward the second end 26 of the shelves 12. The exhaust vents 44 are configured to direct air substantially parallel to the planer surface of each shelf 12. The exhaust vents 44 are positioned between each shelf 12 to form an individual flow of air over each shelf 12.

Referring to FIG. 3, baffles 48 may be included in the housing 34 to deflect the air flow within the housing toward the exhaust vents 44. Additionally, the fan 30 and housing 34 may include a scented dryer sheet 52 anywhere upstream or downstream of the fan 30 and positioned within the housing 34 or over one or more of the vents 40. The scented sheet adds a scent to the air flow before being sent over the clothes (not shown) on each shelf 12. A rocker switch 38 positioned on the top of the extension arm 42 is electrically connected to the motor 32 to turn the motor 32 ON or OFF. Turning the switch 38 ON powers the fan 30 and directs air over clothes placed on the shelves 12. An indent 50 is provided on the back of the extension arm 42 to provide a handle for transporting and positioning the dryer 10.

In operation, the drying shelves 12a, 12b, 12c, 12d, 12e are mounted to the extension arm 42 as is shown in FIG. 1. Damp clothes (not shown) are positioned on the fabric 28 and the on/off rocker switch 38 is actuated to power the motor 32. The motor 32 drives the fans 30a, 30b, which draw air into the housing 34 through the central intake vents 40b and the side intake vents 40a. The air is urged into the extension arm 42 of the housing 34 and is urged out of the exhaust vents 44. The air flows over the clothes, thereby drying the clothes that are positioned on the drying shelves 12a, 12b, 12c, 12d, 12e. At the conclusion of drying, the clothes are removed from the drying shelves 12a, 12b, 12c, 12d, 12e and the shelves 12a, 12b, 12c, 12d, 12e are disassembled from the housing 34. The shelves 12a, 12b, 12c, 12d, 12e and legs 36 may be stored by stacking proximate to the housing 34 or may be separately stored.

It will be appreciated by those skilled in the art that changes could be made to the embodiments described above without departing from the broad inventive concept thereof. It is understood, therefore, that this invention is not limited to the particular embodiment disclosed, but it is intended to cover modifications within the spirit and scope of the present invention as defined by the appended claims.

1. A clothes dryer comprising:
a plurality of generally parallel shelves, each shelf including at least an outer frame having a first end and a second end and fabric extending across the frame to form a substantially planar surface;
a fan; and
a housing enclosing the fan, the housing having at least one air intake vent, an extension arm supporting the second end of each shelf and including a plurality of air exhaust vents configured to direct air substantially parallel to the planar surface of each shelf.

2. The clothes dryer of claim 1, wherein the fabric is comprised of a mesh material.

3. The clothes dryer of claim 1, wherein at least some of the frames are supported at the first end by at least one post, the first end of the bottommost shelf being supported from a support surface by at least one leg.

4. The clothes dryer of claim 3 wherein the outer frames, the at least one post and the at least one leg are comprised of detachable segments and the shelves are removable from the housing.

5. The clothes dryer of claim 1, wherein the exhaust vents are positioned above each shelf to form an individual flow of air for each shelf.

6. The clothes dryer of claim 1, wherein the housing includes a scented sheet.

7. The clothes dryer of claim 1, wherein the fan and air intake is located below the bottommost shelf

8. The clothes dryer of claim 1, wherein the shelves are generally equally spaced.

9. A clothes dryer comprising:
a plurality of generally parallel shelves, each shelf having a first end and a second end and including an outer frame, fabric extending across each frame to form a substantially planar surface,
a fan; and
a housing enclosing the fan, the housing having at least one air intake vent in fluid communication with the fan, the housing forming a generally hollow extension arm fluidly connected to the fan, the extension arm having a corresponding plurality of generally parallel rows of air exhaust vents aligned with the shelves and configured to direct air substantially parallel to the planar surface of each shelf.

10. The clothes dryer of claim 9, wherein the frame is comprised of four cylindrical hollow tubes joined together by four corner fittings.

11. The clothes dryer of claim 10, wherein a plurality of posts extends from the corner fittings for connecting and spacing adjacent shelves.

12. The clothes dryer of claim 10, wherein the fabric has at least two loops formed around an outer periphery each for receiving one of the four tubes.

13. The clothes dryer of claim 9, wherein the dryer has three substantially open sides.

14. The clothes dryer of claim 9, wherein the fan has two impellers, each impeller positioned proximate a lateral side of the housing.

15. The clothes dryer of claim 9, wherein the extension arm includes at least one baffle for deflecting air toward the exhaust vents.

16. The clothes dryer of claim 9, wherein at least some of the frames are supported at the first end by at least one post, the first end of the bottommost shelf being supported from a support surface by at least one leg.

17. The clothes dryer of claim 9, wherein the fan is located entirely below the bottommost shelf.

18. A clothes dryer comprising:
a plurality of generally parallel shelves, each shelf having a first end and a second end and including an outer frame, fabric extending across each frame to form a substantially planar surface,
a fan; and
a housing enclosing the fan, the housing having at least one air intake vent in fluid communication with the fan, the housing forming a generally hollow extension arm fluidly connected to the fan, the extension arm having a plurality of air exhaust vents configured to direct air substantially parallel to the planar surface of each shelf, the extension arm having a plurality of support members for supporting a first end of each shelf.

19. The clothes dryer of claim 18, wherein the support members form upwardly curved hooks for releasably attaching to a first end of each shelf.

20. A clothes dryer comprising:
a plurality of generally parallel shelves, each shelf having a support frame and three generally unobstructed sides, a support surface extending across each frame to form a substantially planar surface;
a fan; and
a housing enclosing the fan, the housing having at least one air intake vent proximate the fan, the housing forming a generally hollow extension arm fluidly connected to the fan and operably connected to the shelves, the extension arm having a plurality of air exhaust vents configured to direct air substantially parallel to the planar surface of each shelf.
